(19) United States
(12) Patent Application Publication
(10) Pub. No.: US 2025/0188989 A1
(43) Pub. Date: Jun. 12, 2025

(54) METHOD FOR PRODUCING A SIDE WALL FOR A DRAWER

(71) Applicant: Julius Blum GmbH, Hoechst (AT)

(72) Inventor: Martin BISCHOF, Schroecken (AT)

(21) Appl. No.: 19/060,213

(22) Filed: Feb. 21, 2025

Related U.S. Application Data
(63) Continuation of application No. PCT/AT2023/060296, filed on Aug. 30, 2023.

(30) Foreign Application Priority Data
Sep. 9, 2022 (AT) A 50692/2022

(51) Int. Cl. F16C 29/02

(52) U.S. Cl. CPC F16C 29/02

(57) ABSTRACT

A method is provided for producing a side wall for a drawer, the drawer including a support profile consisting at least partially of a metallic material and a hollow profile consisting at least partially of a metallic material. The method includes welding the support profile and the hollow profile to one another by a laser welded connection. The support profile and/or the hollow profile are provided with an embossing prior to welding to increase an energy absorption of laser light of the laser to form the laser welded connection in a region and/or around the region of the laser welded connection, and the embossing is at least partially melted during the welding.

The present application is a continuation of International Application PCT/AT2023/060296, filed Aug. 30, 2023. Thus, all of the subject matter of International Application PCT/AT2023/060296 is incorporated herein by reference.

### BACKGROUND OF THE INVENTION

The invention relates to a method for producing a side wall for a drawer, comprising at least one support profile consisting at least in portions of a metallic material and at least one hollow profile consisting at least in portions of a metallic material. The at least one support profile and the at least one hollow profile are welded to one another by at least one laser welded connection. Furthermore, the invention relates to a side wall for a drawer, comprising at least one support profile and at least one hollow profile, and the at least one support profile and the at least one hollow profile are formed at least partially from a metallic material and welded to one another by a laser welded connection. Furthermore, the invention relates to a support profile for such a side wall. Furthermore, the invention relates to an arrangement comprising at least one laser and at least one such side wall.

From the prior art, side walls for drawers are known which comprise a support profile and a hollow profile made of metal, wherein the support profile and the hollow profile are connected to each other by a laser via a laser welded connection.

A disadvantage of the prior art is that in order to ensure a safe and proper laser welded connection while maintaining the functionality of the support profile as a container rail, positions for the laser welded connections must be located deep in the support profile and these positions for the laser welded connections are difficult to access for lasers due to their construction sizes, particularly in the case of narrow support profiles. Therefore, the laser must be positioned outside the support profile at a distance from the desired laser welded connection in order to emit laser light at an unfavorable angle and at a long distance from the material to be welded. Due to the unfavorable angle, a high degree of laser light intended for the laser welded connection is reflected, at least temporarily, during the welding process, resulting in unused and thus lost laser intensity and energy and also causing undesirable heating of regions of the side wall not intended for laser welded connections (possibly with deformations). In the case of improper laser welded connections, the service life of drawers is reduced and there is a risk of the support profile becoming undesirably detached from the hollow profile during use of the side wall. In addition, a visually flawless appearance of laser welded connections is essential, otherwise it will give the impression that the sidewall is not safe to use under load.

### SUMMARY OF THE INVENTION

The object of the present invention is therefore to provide a method for producing a side wall, a side wall as well as a support profile and an arrangement which are improved with respect to the prior art, in which the drawbacks of the prior art are at least partially eliminated, and which are characterized in particular by a reduced laser power requirement for the laser welded connection and/or an improved quality of the laser welded connection with higher strength of the side wall.

It is therefore provided according to the invention that the at least one support profile and/or the at least one hollow profile has/have before welding at least one embossing for increasing an energy absorption of laser light from at least one laser for forming the at least one laser welded connection in a region and/or around the region of the at least one laser welded connection and the at least one embossing is melted at least in some regions during welding.

This makes it possible for the side wall—in particular the at least one support profile and/or the at least one hollow profile—to be made particularly narrow, thereby creating a particularly aesthetically pleasing drawer with increased storage space.

In addition, the at least one laser welded connection can be arranged particularly deep in the side wall or the at least one support profile, whereby the side wall can be adapted particularly flexibly to specific requirements. Limiting factors for the welding process such as proximity to the at least one laser or angle of incidence of laser light on the welding point close to a right angle or a normal can be significantly reduced by the at least one embossing and can be conveniently adapted via a specific shape or geometry of the at least one embossing.

In the prior art, the at least one laser must also be brought very close to the side wall and/or operated with a high laser power in order to be able to generate an energy input required for melting the material despite reflection. In particular, due to this fact, a sensitive and expensive optics of at least one laser becomes contaminated and bundling a laser beam for focusing is particularly complex. In the present invention, a spacing and/or laser power of the at least one laser can be optimally adjusted, wherein the at least one laser can also be protected from contamination.

The at least one embossing can ensure that a laser beam of the at least one laser can impinge on the side wall essentially at a right angle to the welding in essentially any structural configuration. The at least one embossing can greatly reduce the degree of reflection of laser light intended for welding, and heating away from the at least one laser welded connection can also be effectively inhibited.

By increasing the energy absorption at the desired welding point, energy from at least one laser can be saved and damage due to defective laser welded connections can be prevented.

In addition, the positive effect can be that the side wall in the region of at least one laser welded connection is more resilient and also higher loads on a drawer front wall or drawer rear wall are made possible. This can be advantageous, for example, if the inclination adjustment of a diaphragm is achieved via a railing bar, wherein application ranges such as dimensioning optimization are widely spread.

In general, the at least one embossing can be completely melted away during the laser welded connection, wherein the at least one embossing is preferably only partially melted. In other words, an edge region of embossing can remain around the at least one laser welded connection in order, for example, to be able to align the at least one laser with reduced accuracy and/or to be able to exclude undesirable reflection effects in the edge region of the embossing.

As stated at the outset, protection is also sought for a side wall for a drawer, comprising at least one support profile and at least one hollow profile, wherein the at least one support profile and the at least one hollow profile are formed at least in portions from a metallic material and welded to one another by a laser welded connection. The at least one support profile and/or the at least one hollow profile comprises/comprise at least one embossing in a region and/or around the region of the at least one laser welded connection for increasing an energy absorption of laser light from at least one laser for forming the at least one laser welded connection.

The at least one embossing can be used, for example, as an indicator for an intended position of the at least one laser welded connection, preferably to be detected automatically and/or via a camera system. A number of embossings and/or positions of the at least one embossing can be adjusted depending on parameters of the side wall such as load capacity, dimensions, etc. The at least one support profile can be in the form of a container rail, which can generally be used to connect the side wall to a drawer bottom. The at least one hollow profile can be in the form of a frame hat, which can generally be used for at least partially arranging at least one mounting device for a drawer rear wall or a drawer front wall within the at least one hollow profile.

The side wall is particularly preferably in the form of a drawer side wall, a container side wall or the like. A drawer with a drawer front wall, a drawer rear wall, a drawer bottom and two such side walls is preferred, wherein mounting devices are provided for fastening the drawer front wall and/or the drawer rear wall to the side walls.

Preferably, in a preparatory method step, the at least one support profile and/or the at least one hollow profile is or are provided, preferably by rolling and/or bending.

As stated at the outset, protection is also sought for a support profile for such a side wall, wherein the support profile is formed at least in portions from a metallic material, characterized in that the support profile, in particular on an inner side facing an interior of the support profile and/or on at least one lateral web pointing in the vertical direction when the support profile is in use, comprises at least one embossing for increasing an energy absorption of laser light from at least one laser for forming at least one laser welded connection with at least one hollow profile.

For example, embossings can be arranged along the lateral web and/or on the lateral web on the inside and/or on both lateral webs of the support profile and/or the hollow profile, which are preferably aligned parallel to one another.

As stated at the outset, protection is also sought for an arrangement comprising at least one laser and at least one such side wall. The at least one laser for introducing the at least one laser welded connection, in particular in such a method, is aligned with a laser emission opening at an acute angle, of preferably 15° to 30°, particularly preferably 20° to 25°, to a direction that is vertical in the use state of the at least one side wall, so that laser light can be emitted, in particular directly, essentially at a right angle onto a flank of the at least one embossing.

This ensures the positive property that at least one laser does not have to be maneuvered closer to the side wall, and no material-specific characteristics that differ from those materials conventionally used in the furniture industry have to be provided to increase the energy input at the welding point. In particular, with narrow side walls or support profiles, a connection via rivets is not possible, wherein a disk laser, for example, can be used to weld the support profile.

A spacing between the laser and the side wall during welding is preferably in the range between 5 cm and 50 cm, particularly preferably between 10 cm and 40 cm, further preferably between 15 cm and 25 cm.

Advantageous embodiments of the invention are defined in the dependent claims.

It is particularly preferable that, before welding, the at least one embossing for increasing an energy absorption of laser light is arranged in a region and/or around the region of the at least one laser welded connection on the at least one support profile and/or the at least one hollow profile.

Since the at least one embossing represents a structural element of the side wall, no changes are to be made to the at least one laser such as focus width, intensity, pulse duration, irradiation duration or the like. It can be used with a wide variety of lasers with different dimensions and properties.

According to an advantageous embodiment of the invention, the at least one embossing is arranged on an inner side facing an interior of the at least one support profile, preferably on at least one lateral web of the at least one support profile pointing in the vertical direction when the side wall is in use.

In the case of laser welded connections which point into an external space, accessibility by at least one laser is less problematic, although a particularly advantageous integration into a production cycle can also be ensured here. By providing at least one embossing in the interior, the problem of accessibility by at least one laser without complex structures (such as mirrors or split profiles) can be overcome.

Advantageously, at least two, preferably exactly three, embossings are provided and/or the at least one embossing is introduced into the at least one support profile and/or the at least one hollow profile in such a way that the at least one embossing
is present in the form of a, preferably wave-shaped, corrugation, preferably with at least two, particularly preferably at least five, more particularly preferably ten, elevations, and/or
has a substantially rectangular cross-section and/or is arranged locally, and/or
is arranged along a longitudinal direction of the side wall in the region of a free end, preferably at a distance of at least five times a material thickness of the at least one support profile, and/or is centrally arranged, and/or
is arranged orthogonal to the longitudinal direction from a free end at a distance of at least ten times the material thickness of the support profile and/or starting from an upper side of the at least one support profile arranged in the use state of the side wall in the first third along a lateral web of the at least one support profile, and/or
is arranged, in the use state of the side wall, on a lateral web of the at least one support profile and/or the at least one hollow profile, and/or
has a depth of at least one fifth and/or a maximum of one half of the material thickness of the at least one support profile, and/or
forms, on a side of the material facing away from the at least one embossing, a preferably substantially flat contact region for the at least one hollow profile and/or the at least one support profile.

Characteristics of the at least one embossing such as depth, geometry, shape and/or positioning on the side wall can be individually adapted to the conditions and/or requirements of the side wall. If the material thickness varies, it can be defined, for example, by an average or maximum material thickness. Free ends are generally present for both the at least one support profile and the at least one hollow profile in the vertical direction (for example as a maximum distance along this degree of freedom) and in the longitudinal direction.

It has proven to be advantageous that the elevations each have two flanks, preferably tapering pointedly towards each other:
which enclose an angle in the range between 70° and 110°, preferably substantially a right angle, to each other, and/or
wherein one of the two flanks is oriented relative to the at least one support profile and/or the at least one hollow profile such that a normal to the flank points away from the side wall without contact between two lateral webs of the at least one support profile and/or the at least one hollow profile, and/or
wherein the two flanks have a flank height in the range between 0.05 mm and 0.2 mm, preferably between 0.1 mm and 0.15 mm, and/or at least one of the two flanks has a flank length between 0.1 mm and 0.25 mm, preferably between 0.15 mm and 0.2 mm, and/or wherein the elevations have a flank angle between 15° and 40°, preferably between 25° and 30°, relative to a lateral web of the at least one support profile and/or the at least one hollow profile and/or two adjacent elevations are spaced apart from one another by between 0.2 mm and 0.5 mm, preferably between 0.3 mm and 0.4 mm.

Properties of the at least one embossing such as geometry and/or alignment of the flanks can be determined by the laser light of the at least one laser and/or dimensions of components of the side wall in order to make a manufacturing process of the side wall particularly efficient.

According to an advantageous embodiment of the invention, the at least one laser welded connection is introduced in the form of a point-like or linear laser welded connection. Particularly preferred are point-like welds which extend at least in portions within a lateral extent of the at least one embossing.

It has proven advantageous that at least one coating, preferably a plastic coating, is applied to the at least one support profile and/or the at least one hollow profile, preferably in the region of the at least one embossing, which coating is removed before or during the welding, preferably with the at least one laser and/or in regions.

The at least one coating can, for example, be provided for a specific visual appearance of the side wall, wherein the at least one coating may be undesirable for the at least one laser welded connection, and/or—for example due to composition and/or coloring—increase an absorption of laser light at least temporarily at the beginning of the weld.

Evaporating or removing the at least one coating prior to welding with the at least one laser can reduce or eliminate an amount of substances detrimental to the welding, such as organic substrate and/or pollutants.

An advantageous variant consists in that the at least one laser for introducing the at least one laser welded connection with a laser emission opening is oriented at an acute angle, preferably 15° to 30°, particularly preferably 20° to 25°, to a direction that is vertical in the use state of the side wall, wherein it is preferably provided that laser light is emitted substantially at a right angle onto one of the two flanks of the at least one embossing that may be present.

It is particularly preferred that at least one mounting device formed at least in portions from a metallic material is provided for connecting the side wall to a drawer rear wall or a drawer front wall. The mounting device is welded to the at least one support profile by at least one laser weld seam, and in the region of the at least one laser weld seam, a laser deformation separate from the at least one laser weld seam is caused by irradiation with laser light.

This allows additional laser treatment to be carried out in the region of the welding in order to make the side wall more stable and to prevent at least one mounting device from tearing off. In other words, during the welding operation for fastening the at least one mounting device, heat is additionally introduced into the at least one support profile with the aid of at least one laser. This causes at least one support profile to deform slightly and bend upwards. Thus, stresses are deliberately generated in the at least one support profile, which result in a preferred deformation.

With certain material qualities, structural changes can also occur, resulting in a hardening process.

Due to the additional laser treatment, the at least one support profile can bear greater loads, whereby higher loads on the drawer rear wall or drawer front wall connected to the at least one mounting device are possible. This is an advantage, for example, if the inclination adjustment of the drawer front wall is achieved via the railing bar.

In a preferred embodiment of the invention:
the at least one laser weld seam is arranged predominantly at locations on the at least one support profile at which the at least one mounting device and the at least one support profile are in contact, and/or
the at least one laser deformation is arranged predominantly at locations on the at least one support profile at which the at least one mounting device and the at least one support profile are not in contact, and/or
the at least one laser deformation is arranged offset to the at least one laser weld seam on the at least one support profile, and/or
the at least one laser deformation and the at least one laser weld seam are arranged relative to one another in such a way that the laser deformation and the at least one laser weld seam have at least one intersection point, and/or that the at least one laser deformation extends in a direction transverse to a longitudinal direction of the side wall over a greater width than the at least one laser weld seam, and/or
the at least one laser deformation is formed at least in portions linearly in the form of a zigzag, and/or
the at least one laser weld seam and the at least one laser deformation are produced with the same laser, wherein the focus of the laser is adjusted, preferably widened, after the production of the at least one laser weld seam and before the production of the at least one laser deformation.

In general, the same laser can also be used for the at least one laser welded connection and the at least one laser weld seam, wherein the laser sequentially processes the regions of the side wall to be processed. In general, different lasers or a large number of similar lasers can be used for the individual heat treatments, at least partially—for example, for varying positions along the side wall.

It is particularly preferable that the at least one laser weld seam and the at least one laser deformation are linear at least in portions. The at least one laser weld seam and the laser deformation have a different line width, and preferably the laser deformation has a larger line width than the at least one laser weld seam.

The side wall can have the constructive or structural features of the method claims, wherein features of the device claims of the side wall are applicable in an analogous manner to the method claims.

### BRIEF DESCRIPTION OF THE DRAWINGS

Further details and advantages of the present invention will be explained in more detail below with reference to the drawings, in which:

FIGS. 1a, 1b show a side wall according to a particularly preferred exemplary embodiment in two perspective views with varying viewing angle of an embossing in a support profile,

FIG. 1c, 1d show the side wall according to the embodiment of FIG. 1a with an enlarged detailed section in the region of the embossing in perspective view,

FIG. 2 shows the support profile of the side wall according to the embodiment of FIG. 1a isolated from a hollow profile in perspective view,

FIG. 3a, 3b show the side wall according to the embodiment of FIG. 1a in a view from the side with an enlarged sectional view and an enlarged detailed view in the region of the embossing,

FIG. 3c, 3d show the side wall according to the embodiment of FIG. 3a during irradiation of the embossing by a laser to form a laser welded connection as well as an enlarged detail section of the embossing, and

FIG. 4a-4d show a side wall according to another preferred exemplary embodiment in a view from below with three enlarged detail sections in the region of a laser weld seam.

### DETAILED DESCRIPTION OF THE INVENTION

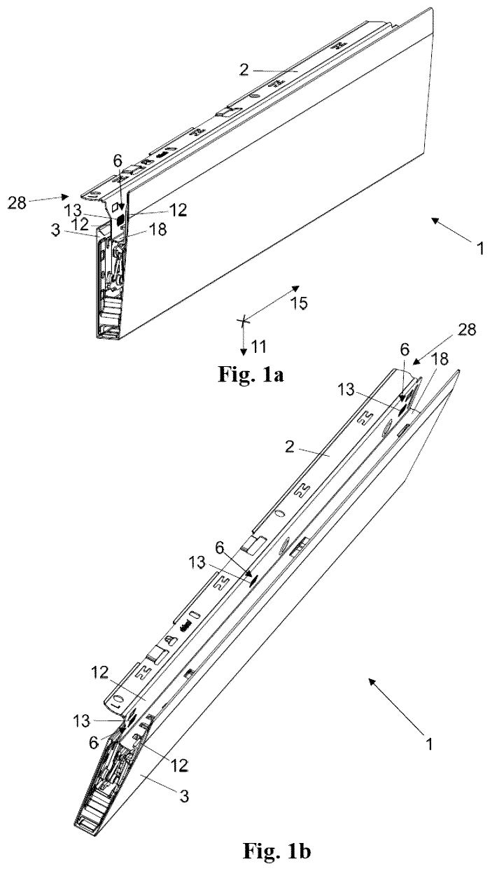

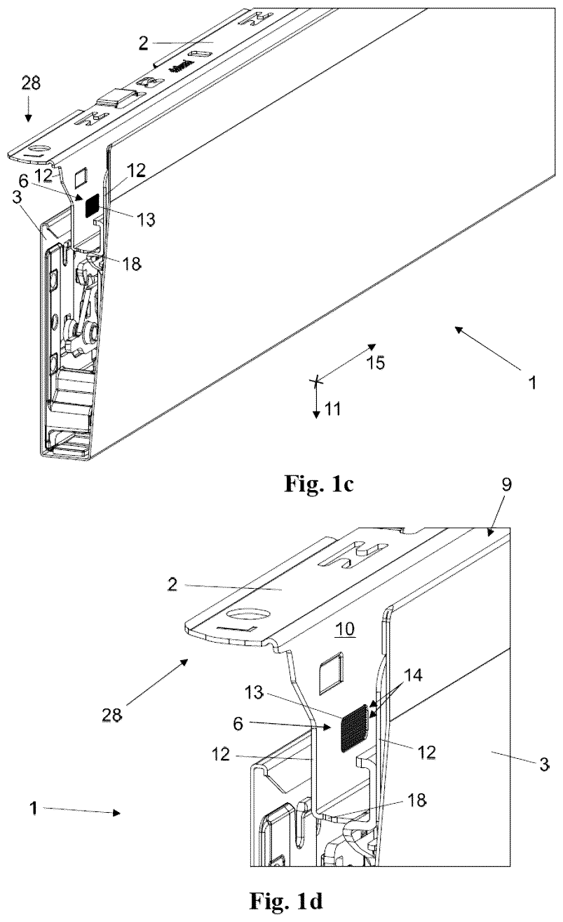

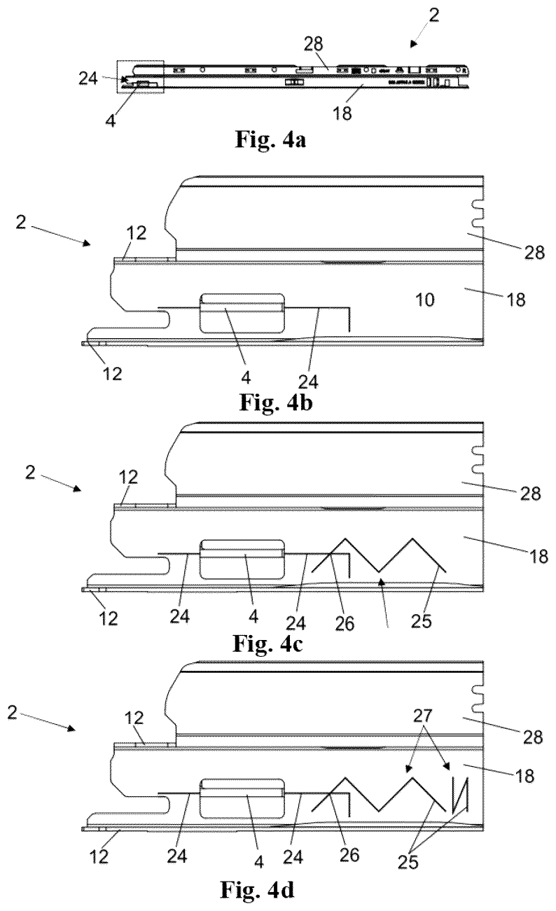

FIG. 1a shows a side wall 1 for a drawer, comprising a support profile 2 in the form of a container rail for connecting the side wall to a drawer bottom and a hollow profile 3 in the form of a frame hat for arranging mounting devices 4 for a drawer rear wall and a drawer front wall within the hollow profile 3 (cf. FIG. 4b-4d).

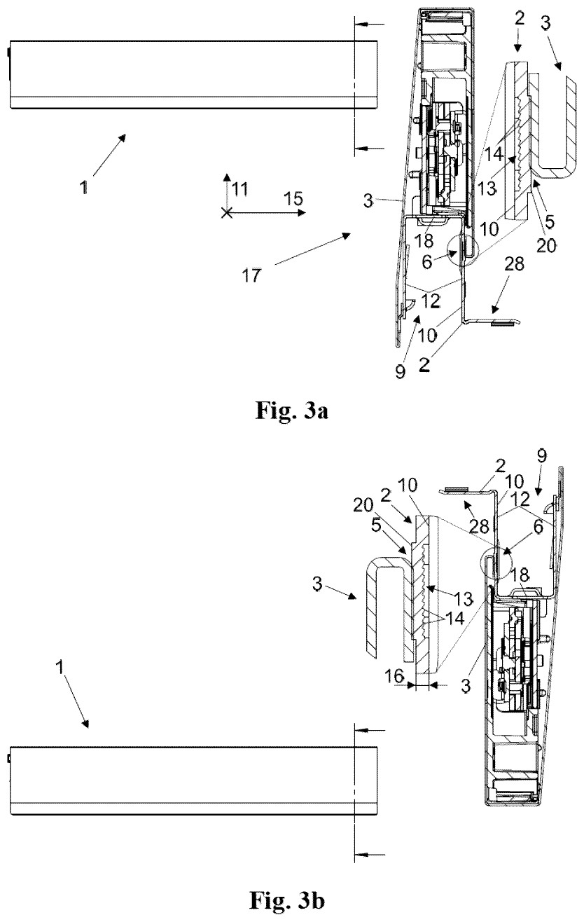

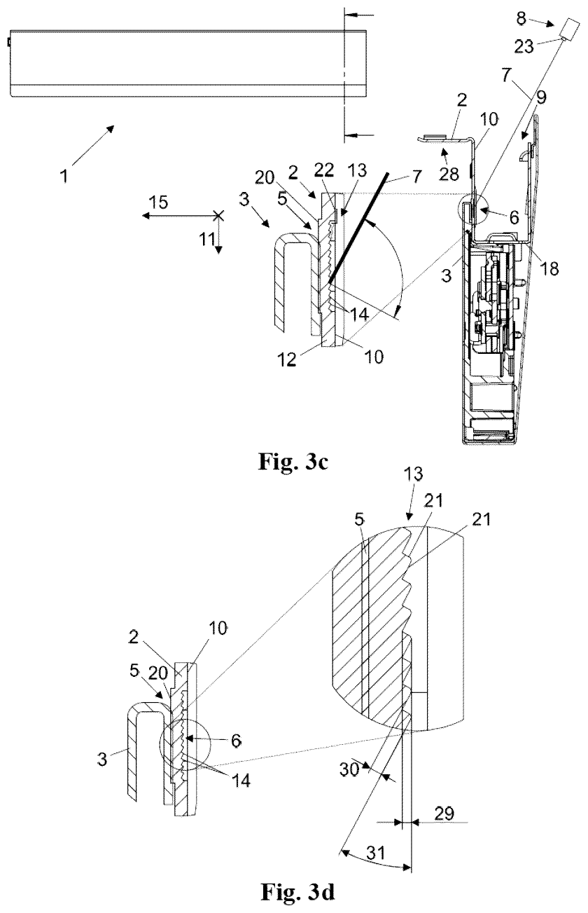

The support profile 2 and the hollow profile 3 were provided at least in portions containing a metallic material in order to be welded to one another by means of a laser welded connection 5. In order to improve the quality of the laser welded connection 5 (see FIG. 3a-3d), the support profile 2 comprises a plurality of embossings 6 in and around a region of the laser welded connection 5 to be attached to the side wall 1 in order to increase the energy absorption of laser light 7 of a laser 8 for forming the laser welded connection 5.

The embossings 6 are arranged on the support profile 2. Alternatively or additionally, embossings 6 can be arranged on the hollow profile 3.

FIG. 1b differs from FIG. 1a only in that the side wall 1 is viewed from a different viewing direction, wherein it can be seen that exactly three embossings 6 are provided. In general, the number of embossings 6 is arbitrary, wherein, for example, further embossings 6 can be arranged opposite one another on the support profile 2 (or the hollow profile 3).

FIG. 1c shows a free end of the support profile 2 in the longitudinal direction 15 of the side wall 1 as well as free ends of the support profile 2—formed by an upper side 18 arranged in the use state 17 of the side wall and an opposite lower edge of the support profile 2—in the vertical direction 11 of the side wall 1.

Along the longitudinal direction 15 of the side wall 1, embossings 6 are arranged in the region of the free end at a distance of at least five times the material thickness 16 of the support profile 2 and in the middle of the support profile 2 (hidden in the illustration). Orthogonal to the longitudinal direction 15, the embossings 6 are arranged from the lower edge of the lateral web 12 of the support profile 2 formed in the use state 17 at a distance of at least ten times the material thickness 16 of the support profile 2 and starting from the upper side 18 of the support profile 2 arranged in the use state 17 of the side wall 1 in the first third along a lateral web 12 of the support profile 2.

The support profile 2 has a further lateral web 12 aligned parallel to the lateral web 12. The embossing 2 is located closer to the upper side 18 in the vertical direction 11 than to the lower edge of the support profile, which is why a laser welded connection 5 without embossing 6 is complex and difficult to generate due to the structural dimensions of the side wall.

The embossings 6 are introduced into the support profile 2 (possibly also possible in the hollow profile 3) such that the embossings 6 have a rectangular cross-section with rounded corners, are arranged on a local region of the side wall and are positioned on the lateral web 12 of the support profile 2 in the use state 17 of the side wall 1.

FIG. 1d shows a section of the side wall 1 in the region of an embossing 6 in an enlarged view. The embossings 6 are arranged on an inner side 10 of the support profile 2 facing an interior 9 of the support profile 2—on the lateral web 12 pointing in the vertical direction 11 in the state of use 17 of the side wall 1.

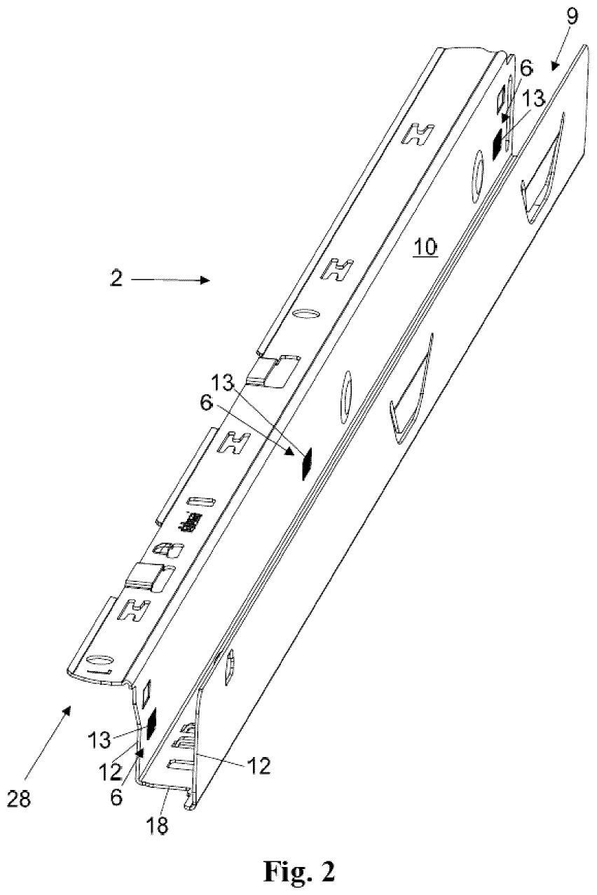

FIG. 2 shows a particularly preferred embodiment of the support profile 2 for the side wall 1, wherein the support profile 2 consists of metal and the embossings 6 are arranged on the inner side 10 facing the interior 9 of the support profile 2 and on the lateral web 12 pointing in the vertical direction 11 when the support profile 2 is in use, in order to increase the energy absorption of laser light 7 of a laser 8 for forming laser welded connections 5 with the hollow profile 3.

The support profile 2 has a transverse web 28 which is aligned orthogonally to both lateral webs 12 of the support profile 2 and, in a state mounted on the hollow profile 3, both lateral webs 12 of the hollow profile 3.

FIG. 3a shows a side view of the side wall 1 with a sectional view through the side wall and an enlarged detailed view in the region of an embossing 6 or laser welded connection 5.

The laser welded connection 5 is shown schematically, with the embossing 6 shown in cross-section completely preserved for illustrative purposes-this is generally not provided for in the region of the laser welded connection 5 due to a melting process of material. The laser welded connection 5 as a material connection can be combined with other fastening connections between the support profile 2 and the hollow profile 3. For example, screw, nail, clamp, form-fitting connections or the like can be used.

In the position of use 17, the side wall 1 is oriented for connection to other components of a drawer.

FIG. 3b differs from FIG. 3a only in that the side wall 1 has been rotated by 180°. Such an orientation can be used for the assembly of the side wall 1, wherein the laser welded connection 5 is generated by emitting laser light 7 from above onto the embossing 6 positioned in the interior 9 and between the two lateral webs 12. However, the orientation of the side wall 1 during a manufacturing process is generally arbitrary.

The embossing 6 has a depth between one fifth and one half of the material thickness 16 of the support profile 2. The embossing 6 is in the form of a wave-shaped corrugation 13, wherein the corrugation 13 has a plurality of elevations 14. On a side of the material of the support profile 2 facing away from the embossing 6, a contact region 20 is formed by the embossing 6, which can be used for linear or area contact between the lateral web 12 of the support profile 2 and a lateral web of the hollow profile 3 for the defined contact for the laser welded connection 5.

The laser welded connection 5 can, for example, be in the form of a point-like or linear laser weld seam.

FIG. 3c shows an arrangement of a laser 8 and the side wall 1, wherein the laser 8 (the number is generally arbitrary) for introducing the laser welded connection 5 with a laser emission opening 23 is oriented at an acute angle between 20° and 25° to the vertical direction 11, so that the laser light 7 of the laser 8 can be emitted directly at a right angle onto flanks 21 (see FIG. 3d) of the embossing 6.

A method for producing the side wall 1 can be exemplified as follows: The metallic support profile 2 and the metallic hollow profile 3 are provided, wherein the embossings 6 are arranged on the support profile 2 in order to increase the energy absorption of laser light 7 before a welding process in a region and around the region of the laser welded connection 5 so that the support profile 2 and the hollow profile 3 are subsequently welded to one another by means of laser welded connections 5 via the embossings 6, wherein at least the support profile 2 has embossings 6 before welding and the embossings 6 are melted at least in some regions during welding.

A coating 22 in the form of a plastic coating can be applied to the support profile 2 or the hollow profile 3 in the region of the embossings 6, which is at least partially removed before or during welding with the laser 8.

The laser 8 has already been oriented at an acute angle to the inner sides 10 of the support profile 2 in order to introduce the laser welded connection 5 with the laser emission opening 23, wherein laser light 7 is emitted at a right angle onto one of the two flanks 21 of the embossing 6 formed by the embossing 6 in order to melt metallic material.

FIG. 3d shows an embossing 6 for a laser welded connection 5 in an enlarged view, wherein it can be seen that the elevations 14 of the corrugation 13 each have two flanks 21 tapering towards one another. A manufacturing-related radius in the transition region of the flanks 21 is generally arbitrary.

The flanks 21 of the corrugation 13 form a right angle to one another, wherein the elevations 14 of the embossing 6 have a flank angle 31 of 28° relative to the lateral web 12 of the support profile 2. The elevations 14 are inclined with their flanks 21, with two adjacent elevations 14 being spaced 0.36 mm apart.

The two flanks 21 form a flank height 29 of 0.125 mm. The two flanks 21 of an elevation 14 have different flank lengths 30, with one flank 21 having a flank length 30 of 0.17 mm.

As can be seen in FIG. 3c, one of the two flanks 21 is respectively oriented relative to the lateral webs 12 of the support profile 2 in such a way that a normal to this flank 21 points away from the side wall 1 without contact between the two lateral webs 12 of the support profile 2 in order to be able to achieve a laser welded connection 5 via the embossing 6 with reduced reflection.

In an analogous structural design, embossings 6 can be provided on the hollow profile 3.

FIG. 4a shows the support profile 2 of the side wall 1 from a bottom side in the direction of the top side 18 as a plate-shaped component of the support profile 2. A dashed region of a free end of the support profile 2 is shown in FIGS. 4b to 4d in various embodiments for connecting or increasing the stability of a mounting device 4.

FIG. 4b shows that the mounting device 4 for connecting the side wall 1 to a drawer rear wall or a drawer front wall was provided with metallic material and was arranged on the support profile 2. The mounting device 4 is welded to the support profile 2 by means of a laser weld seam 24.

FIG. 4c shows that the connection between the support profile 2 and the mounting device 4 in the region of the laser weld seam 24 has a laser deformation 25 that is separate from the laser weld seam 24 and caused by laser light 7.

The laser deformation 25 is arranged predominantly at locations on the support profile 2 where the mounting device 4 and the support profile 2 are designed to have no contact with one another.

The laser weld seam 24 and the laser deformation 25 are linear, wherein the laser weld seam 24 and the laser deformation 25 have a different line width (during the emission of laser light 7 and after completion of the welding process). The laser deformation 25 has a larger line width than the laser weld seam 24.

The laser deformation 25 extends in a direction transverse to a longitudinal direction 15 of the side wall 1 over a greater width than the laser weld seam 24.

The laser deformation 25 is linear and is designed in the form of a zigzag 27.

The laser deformation 25 and the laser weld seam 24 have a common intersection point 26.

FIG. 4d shows that a further laser deformation 25 is provided, which is arranged offset to the laser weld seam 24 on the support profile 2. By means of the laser deformation 25, a hardening process can be achieved during irradiation with laser light 7 as well as an increase in strength.

In the manufacturing process of the side wall 1, the metallic mounting device 4 can be welded to the support profile 2 by means of a laser weld seam 24 or a plurality of spatially separate or interconnected laser weld seams 24, wherein in the region of the laser weld seam 24 a laser deformation 25 separate from the laser weld seam 24 is caused by irradiation with laser light 7.

The laser weld seam 24, the laser deformations 25 and the laser welded connection 5 were produced with the same laser 8, although this is generally not strictly required. For example, only the laser weld seam 24 and the laser deformation 25 can be generated with a laser 8. In this embodiment, the focus of the laser 8 after the generation of the laser weld seam 24 and before the generation of the laser deformation 25 is adjusted in the form of a widening of the focus.

1. A method for producing a side wall for a drawer, the drawer including at least one support profile consisting at least partially of a metallic material and at least one hollow profile consisting at least partially of a metallic material, the method comprising:
welding the at least one support profile and the at least one hollow profile to one another by at least one laser welded connection,
wherein the at least one support profile and/or the at least one hollow profile has/have at least one embossing prior to welding to increase an energy absorption of laser light of at least one laser to form the at least one laser welded connection in a region and/or around the region of the at least one laser welded connection, and the at least one embossing is at least partially melted during the welding.

2. The method according to claim 1, wherein prior to welding, the at least one embossing is arranged for increasing the energy absorption of laser light in a region and/or around the region of the at least one laser welded connection on the at least one support profile and/or the at least one hollow profile.

3. The method according to claim 1, wherein the at least one embossing is arranged on an inner side facing an interior space of the at least one support profile, preferably on at least one lateral web of the at least one support profile pointing in the vertical direction in the state of use of the side wall.

4. The method according to claim 1, wherein at least two, preferably exactly three, embossings are provided and/or the at least one embossing is introduced into the at least one support profile and/or the at least one hollow profile in such a way that the at least one embossing:
is present in the form of a, preferably wave-shaped, corrugation, preferably with at least two, particularly preferably at least five, more particularly preferably ten, elevations, and/or
has a substantially rectangular cross-section and/or is arranged locally, and/or
is arranged along a longitudinal direction of the side wall in the region of a free end, preferably at a distance of at least five times a material thickness of the at least one support profile, and/or is centrally arranged, and/or
is arranged orthogonal to the longitudinal direction from a free end at a distance of at least ten times the material thickness of the support profile and/or starting from an upper side of the at least one support profile arranged in the use state of the side wall in the first third along a lateral web of the at least one support profile, and/or
is arranged, in the use state of the side wall, on a lateral web of the at least one support profile and/or the at least one hollow profile, and/or
has a depth of at least one fifth and/or a maximum of one half of the material thickness of the at least one support profile, and/or
forms, on a side of the material facing away from the at least one embossing, a preferably substantially flat contact region for the at least one hollow profile and/or the at least one support profile.

5. The method according to claim 4, wherein the elevations each have two flanks, preferably tapering pointedly towards one another, and wherein:
the two flanks enclose an angle in the range between 70° and 110°, preferably substantially a right angle, to each other, and/or
one of the two flanks is oriented relative to the at least one support profile and/or the at least one hollow profile in such a way that a normal to the flank points away from the side wall without contact between two lateral webs of the at least one support profile and/or the at least one hollow profile, and/or
the two flanks have a flank height in the range between 0.05 mm and 0.2 mm, preferably between 0.1 mm and 0.15 mm, and/or at least one of the two flanks has a flank length between 0.1 mm and 0.25 mm, preferably between 0.15 mm and 0.2 mm, and/or
the elevations have a flank angle of between 15° and 40°, preferably between 25° and 30°, relative to a lateral web of the at least one support profile and/or the at least one hollow profile and/or two adjacent elevations are spaced apart from one another by between 0.2 mm and 0.5 mm, preferably between 0.3 mm and 0.4 mm.

6. The method according to claim 1, wherein the at least one laser welded connection is introduced in the form of a point-like or linear laser weld seam.

7. The method according to claim 1, wherein at least one coating, preferably a plastic coating, is applied to the at least one support profile and/or the at least one hollow profile, preferably in the region of the at least one embossing, which coating is removed before or during the welding, preferably with the at least one laser and/or in regions.

8. The method according to claim 1, wherein the at least one laser for introducing the at least one laser welded connection is oriented with a laser emission opening at an acute angle, preferably 15° to 30°, particularly preferably 20° to 25°, to a direction which is vertical in the state of use of the side wall, wherein it is preferably provided that laser light is emitted substantially at right angles onto one of the two optional flanks of the at least one embossing.

9. The method according to claim 1, wherein at least one mounting device formed at least in portions from a metallic material is provided for connecting the side wall to a drawer rear wall or a drawer front wall, wherein the at least one mounting device is welded to the at least one support profile by means of at least one laser weld seam and a laser deformation separate from the at least one laser weld seam is produced in the region of the at least one laser weld seam by irradiation with laser light.

10. The method according to claim 9, wherein:
the at least one laser weld seam is arranged predominantly at locations on the at least one support profile at which the at least one mounting device and the at least one support profile are in contact, and/or
the at least one laser deformation is arranged predominantly at locations on the at least one support profile at which the at least one mounting device and the at least one support profile are not in contact, and/or
the at least one laser deformation is arranged offset to the at least one laser weld seam on the at least one support profile, and/or
the at least one laser deformation and the at least one laser weld seam are arranged relative to one another in such a way that the laser deformation and the at least one laser weld seam have at least one intersection point, and/or that the at least one laser deformation extends in a direction transverse to a longitudinal direction of the side wall over a greater width than the at least one laser weld seam, and/or
the at least one laser deformation is formed at least in portions linearly in the form of a zigzag, and/or
the at least one laser weld seam and the at least one laser deformation are produced with the same laser, the focus of the laser being adjusted, preferably widened, after the at least one laser weld seam has been produced and before the at least one laser deformation has been produced.

11. A side wall for a drawer, comprising:
at least one support profile, and
at least one hollow profile,
wherein the at least one support profile and the at least one hollow profile are at least partially formed from a metallic material and are welded together by at least one laser welded connection,
wherein the at least one support profile and/or the at least one hollow profile comprises/comprise, in a region and/or around the region of the at least one laser welded connection, at least one embossing for increasing an energy absorption of laser light of at least one laser for forming the at least one laser welded connection.

12. The side wall according to claim 11, wherein the at least one embossing is arranged on an inner side facing an interior space of the at least one support profile, preferably on at least one lateral web of the at least one support profile pointing in the vertical direction in the state of use of the side wall.

13. The side wall according to claim 11, wherein at least two, preferably exactly three, embossings are provided and/or the at least one embossing is introduced into the at least one support profile and/or the at least one hollow profile in such a way that the at least one embossing:
is present in the form of a, preferably wave-shaped, corrugation, preferably with at least two, particularly preferably at least five, more particularly preferably ten, elevations, and/or
has a substantially rectangular cross-section and/or is arranged locally, and/or
is arranged along a longitudinal direction of the side wall in the region of a free end, preferably at a distance of at least five times a material thickness of the at least one support profile, and/or is centrally arranged, and/or
is arranged orthogonal to the longitudinal direction from a free end at a distance of at least ten times the material thickness of the support profile and/or starting from an upper side of the at least one support profile arranged in the use state of the side wall in the first third along a lateral web of the at least one support profile, and/or
is arranged, in the use state of the side wall, on a lateral web of the at least one support profile and/or the at least one hollow profile, and/or
has a depth of at least one fifth and/or a maximum of one half of the material thickness of the at least one support profile, and/or
forms, on a side of the material facing away from the at least one embossing, a preferably substantially flat contact region for the at least one hollow profile and/or the at least one support profile.

14. The side wall according to claim 13, wherein the elevations each have two flanks, preferably tapering pointedly towards one another, and wherein:
the two flanks enclose an angle in the range between 70° and 110°, preferably substantially a right angle, to each other, and/or
one of the two flanks is oriented relative to the at least one support profile and/or the at least one hollow profile in such a way that a normal to the flank points away from the side wall without contact between two lateral webs of the at least one support profile and/or the at least one hollow profile, and/or
the two flanks have a flank height in the range between 0.05 mm and 0.2 mm, preferably between 0.1 mm and 0.15 mm, and/or at least one of the two flanks has a flank length (30) between 0.1 mm and 0.25 mm, preferably between 0.15 mm and 0.2 mm, and/or
the elevations have a flank angle of between 15° and 40°, preferably between 25° and 30°,relative to a lateral web of the at least one support profile and/or the at least one hollow profile and/or two adjacent elevations are spaced apart from one another by between 0.2 mm and 0.5 mm, preferably between 0.3 mm and 0.4 mm.

15. The side wall according to claim 1, wherein the at least one laser welded connection is in the form of a point-like or linear laser weld seam.

16. The side wall according to claim 11, wherein the at least one support profile and/or the at least one hollow profile, comprises at least one coating, preferably a plastic coating preferably around a region of the at least one embossing.

17. The side wall according to claim 11, further comprising at least one mounting device for connecting the side wall to a drawer rear wall or drawer front wall, wherein the at least one mounting device is formed at least in portions from a metallic material and is welded to the at least one support profile by means of at least one laser weld seam and has a laser deformation separate from the at least one laser weld seam produced in the region of the at least one laser weld seam by laser light.

18. The side wall according to claim 17, wherein:
the at least one laser deformation is arranged predominantly at locations on the at least one support profile at which the at least one mounting device and the at least one support profile are not in contact to each other, and/or
the at least one laser deformation is arranged offset to the at least one laser weld seam on the at least one support profile, and/or
the at least one laser deformation and the at least one laser weld seam have at least one intersection point, and/or
the at least one laser deformation extends in a direction transverse to a longitudinal direction of the side wall over a greater width than the at least one laser weld seam, and/or
the at least one laser deformation is at least partially linear and/or has a zigzag, and/or
the at least one laser weld seam and the at least one laser deformation are formed linearly at least in portions, and wherein the at least one laser weld seam and the laser deformation have a different line width, preferably wherein the laser deformation has a greater line width than the at least one laser weld seam.

19. A support profile for the side wall according to claim 11, wherein the support profile is formed at least in portions from a metallic material, wherein the support profile, in particular on an inner side facing an interior of the support profile and/or on at least one lateral web pointing in the vertical direction in the state of use of the carrier profile, comprises at least one embossing for increasing the energy absorption of laser light of at least one laser for forming at least one laser welded connection with at least one hollow profile.

20. An arrangement comprising:
at least one laser, and
the side wall according to claim 11, wherein the at least one laser is configured to introduce the at least one laser welded connection, and is aligned with a laser emission opening at an acute angle, preferably 15° to 30°, particularly preferably 20° to 25°, to a direction that is vertical in the use state of the at least one side wall, so that laser light can be emitted, in particular directly, essentially at a right angle onto a flank of the at least one embossing.
